(19) United States
(12) Patent Application Publication
(10) Pub. No.: US 2007/0121978 A1
(43) Pub. Date: May 31, 2007

(54) Digital hearing aid enhancing directional performance

(76) Inventor: Soon-Suck Jang, KwangJu (KR)

Correspondence Address: LADAS & PARRY LLP, 224 SOUTH MICHIGAN AVENUE, SUITE 1600, CHICAGO, IL, 60604, US

(21) Appl. No.: 10/574,304

(22) PCT Filed: Jun. 16, 2005
(86) PCT No.: PCT/KR05/01846

§ 371 Date: Apr. 3, 2006

(30) Foreign Application Priority Data
Jun. 30, 2004 (KR) 10-2004-0052145

(51) Int. Cl. H04R 25/00

(52) U.S. Cl. 381/315; 381/328; 381/322

(57) ABSTRACT

A digital hearing aid enhancing a directional performance for a patient who suffers from sole-ear hearing impairments is provided, in which the digital hearing aid cell inserted into one healthy ear is electrically connected with another digital hearing aid cell called an ear cell including a microphone worn in the other troubled ear, via an external electric wire. Two digital hearing aid cells are connected with each other via signal, power, and ground wires to thereby adjust a time delay parameter and thus make a time delay effect between the two microphones, so that a wearer who wears the digital hearing aid can better hear sound which comes from the side opposing the healthy ear, that is, from the troubled ear side.

### TECHNICAL FIELD

The present invention relates to a hearing aid in a medical equipment technological field, and more particularly to, a hearing aid in which each ITE (In-The-Ear) type hearing aid cell is inserted into both ears, and one microphone is incorporated in each hearing aid cell, to thereby adjust a phase between the microphones desirably and make a time delay effect between the two microphones, so that a wearer who wears the digital hearing aid can better hear sound which comes from the side opposing the healthy ear, that is, from the troubled ear side.

### BACKGROUND ART

Among the currently available hearing aids, ITE (In-The_Ear) type hearing aids are widely used. An existing hearing aid for an auditory handicapped person who has one healthy ear and the other ear having suffered from hearing impairments is made of an ITE type hearing aid. Even in the case of a sole-ear auditory handicapped person, he or she has worn hearing aids onto both ears, that is, one healthy ear and the other troubled ear. As a result, since there is no wearing effect of the hearing aid at the healthy ear side, sound signals amplified at the troubled ear side should be transmitted to the healthy ear side via external circuit cables, so as to be heard via the hearing aid worn at the healthy ear side. In this manner, the wearer can hear sounds coming from both the troubled ear side and the healthy ear side.

In the above-described conventional hearing aids for sole-ear auditory handicapped persons, one microphone is incorporated in an ITE type hearing aid cell which is inserted into a troubled ear, and an ear cell including a receiver is inserted into the healthy ear so that signals amplified at the troubled ear side can be heard at the healthy ear side.

The conventional problems occur from a time delay which is produced in the process of converting the electric signals amplified at the troubled ear side into a sound pressure at the healthy ear side. That is, the conventional hearing aid for a sole-ear auditory handicapped person is employed without considering a time delay between the healthy ear side and the troubled ear side. Thus, a wearer who wears the conventional hearing aid for a sole-ear auditory handicapped person may lose a directional sense with respect to sounds. Further, a hearing ability of the healthy ear may be weakened since an ear cell is inserted into the healthy ear.

Meanwhile, a great number of the auditory handicapped persons have one healthy ear and the other troubled ear. Thus, it is necessary to develop a hearing aid for a sole-ear auditory handicapped person. In particular, it is necessary to develop a hearing aid with which sounds coming from both ear sides can be heard well even though the sole-ear auditory handicapped person wears a hearing aid cell and an ear cell in his or her both ears, respectively

### DISCLOSURE OF THE INVENTION

To solve the above problems, it is an object of the present invention to provide a hearing aid with which sounds coming from both ear sides can be heard well even though a sole-ear auditory handicapped person wears a hearing aid cell and an ear cell in his or her both ears, respectively.

It is another object of the present invention to provide a digital hearing aid enhancing a directional performance for a patient who suffers from sole-ear hearing impairments in which the digital hearing aid cell inserted into one healthy ear is electrically connected with another digital hearing aid cell called an ear cell including a microphone worn in the other troubled ear, via an external electric wire.

To accomplish the above object of the present invention, there is provided a hearing aid comprising: a digital ITE (In-The-Ear) type hearing aid cell including a digital amplifier, a microphone and a receiver in one healthy ear; and an ear cell including a microphone in the other troubled ear, wherein the digital hearing aid cell and the ear cell are connected via external electric wires, to thereby enhance a directional performance of the hearing aid.

Preferably, electronic components incorporated in the healthy-ear hearing aid cell are a front microphone, a switch, a receiver, a digital interface connection terminal and a battery door, while an electronic component incorporated in the troubled-ear ear cell is a rear microphone.

Preferably, a time delay parameter in the digital amplifier is designed to adjust a directional performance in the hearing aid.

### BRIEF DESCRIPTION OF THE DRAWINGS

The above and other objects and advantages of the present invention will become more apparent by describing the preferred embodiment thereof in detail with reference to the accompanying drawings in which:

FIG. 1 shows two photographs illustrating a healthy ear at the state where a user has worn an ITE (In-The_Ear) type hearing aid according to the present invention;

FIG. 2 shows two photographs illustrating a troubled ear at the state where a user has worn an ITE (In-The_Ear) type hearing aid cell called an ear cell according to the present invention;

FIG. 3 shows the inner structure of an ITE type digital hearing aid in which digital amplifier chip terminals incorporated in the digital hearing aid are connected with hearing aid electronic components such as microphones, a receiver, a memory diverting switch, a battery door, and an external interface socket; and

FIG. 4 is a pictorial view illustrating a shape where the ITE type hearing aid cell and an ear cell which are applied to the present invention are connected via electric wires.

### BEST MODE FOR CARRYING OUT THE INVENTION

Hereinbelow, a hearing aid for a sole-ear auditory handicapped person according to the present invention will be described with reference to the accompanying drawings.

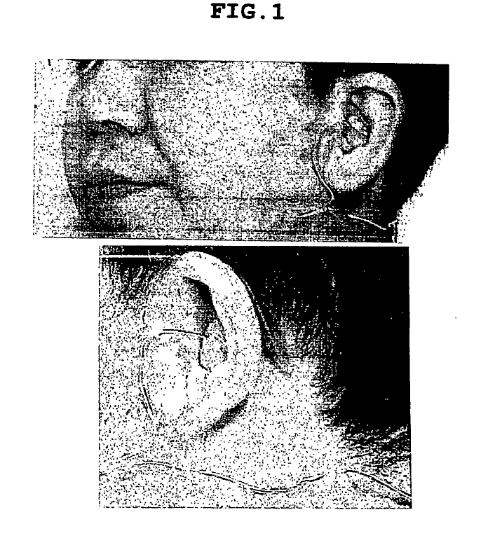

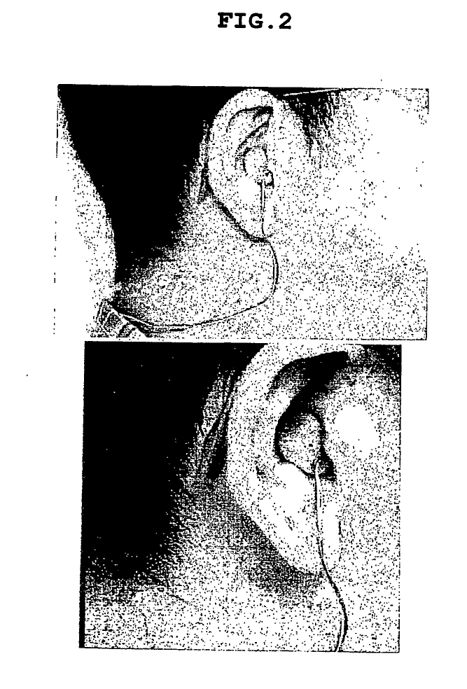

As shown in FIGS. 1 and 2, an ITE (In-The_Ear) type hearing aid according to the present invention includes an ITE (In-The_Ear) type hearing aid cell inserted at one healthy ear side, and an ear cell inserted at the troubled ear side.

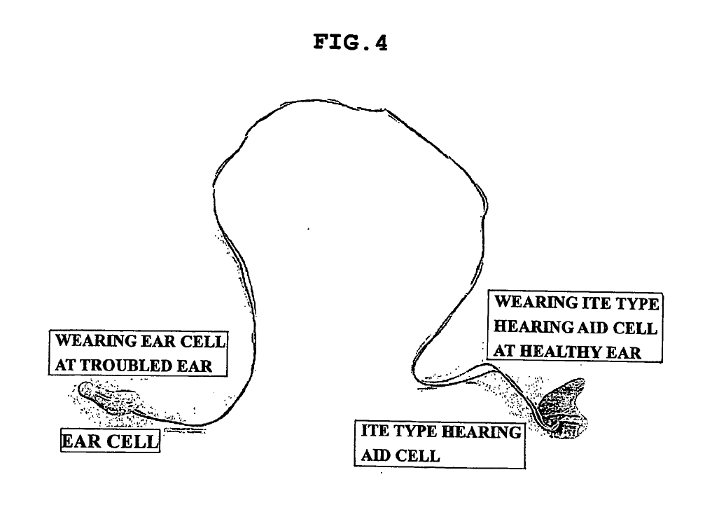

As shown in FIG. 4, an ITE (In-The_Ear) type hearing aid cell inserted at one healthy ear side, and an ear cell inserted at the troubled ear side, are connected with each other via three lines of signal, power, and ground wires.

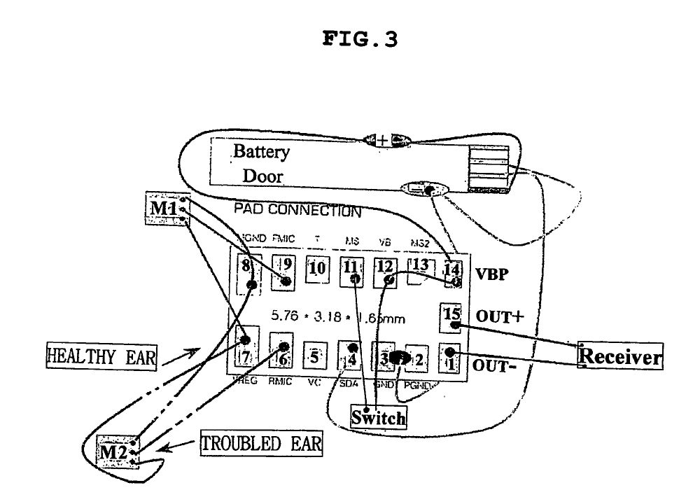

Referring to FIG. 3, in the case of a digital hearing aid cell at the healthy ear side, digital amplifier chip terminals are connected with and soldered to hearing aid electronic components such as microphones, a receiver, a memory diverting switch, a battery door, and an external interface socket via internal wires.

In FIG. 3, a reference symbol Ml denotes a front microphone which is -inserted into a healthy-ear hearing aid cell, and a reference symbol M2 denotes a rear microphone which is inserted into an ear cell at a troubled ear side. That is, a microphone is inserted into the ITE (In-The-Ear) type hearing aid cell and the ear cell, respectively. The digital amplifier chip uses the front and rear microphones simultaneously, to thereby adjust a time delay. For this purpose, the healthy-ear hearing aid cell and the troubled-ear ear cell are connected via three lines of external wires. Also, a switch in FIG. 3 is a memory diverting switch which is incorporated in a healthy-ear hearing aid cell, and a receiver therein is a general receiver which is incorporated in a healthy-ear hearing aid cell. Also, a terminal SDA in a pad connection diagram of FIG. 3 is a connection terminal for digital interface with an external controller personal computer. Also, a battery door is a hearing aid battery chamber which is incorporated in a healthy-ear hearing aid cell, through which a hearing aid dry cell is inserted and released. These components such as the front and rear microphones, the switch, the receiver, the socket and the battery chamber are connected to pad connection terminals of the IC chip on a PCB (Printed Circuit Board).

The electronic components incorporated in the healthy-ear hearing aid cell are the front microphone Ml, the switch, the receiver, the digital interface connection terminal SDA and the battery door, while the electronic component incorporated in the troubled-ear ear cell is the rear microphone M2,

A time delay parameter in a digital amplifier is designed and fabricated so as to adjust a directional performance in a hearing aid. Since a distance between two microphones incorporated at the healthy ear side and the troubled ear side, respectively is a size of the head of a common person, that is, about 18 cm, an effect of an array of the microphones is very excellent to thereby adjust a directional performance as desired.

The present invention provides an effect of enhancing a hearing aid directional performance in which a sole-ear auditory handicapped person who has one healthy ear and the other troubled ear wears an ITE (In-The_Ear) type hearing aid cell and at the healthy ear side and an ear cell incorporated with a microphone at the troubled ear side, and external electric wires are connected between the hearing aid cell and the ear cell.

### INDUSTRIAL APPLICABILITY

As described above, the present invention provides a hearing aid for a sole-ear auditory handicapped person who has one healthy ear and the other troubled ear wears an ITE (In-The_Ear) type hearing aid cell and at the healthy ear side and an ear cell incorporated with a microphone at the troubled ear side, and external electric wires are connected between the hearing aid cell and the ear cell.

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

What is claimed is:

1. A hearing aid comprising:
a digital ITE (In-The-Ear) type hearing aid cell including a digital amplifier, a microphone and a receiver in one healthy ear; and
an ear cell including a microphone in the other troubled ear,
wherein the digital hearing aid cell and the ear cell are connected via external electric wires, to thereby enhance a directional performance of the hearing aid.

2. The hearing aid of claim 1, wherein electronic components incorporated in the healthy-ear hearing aid cell are a front microphone, a switch, a receiver, a digital interface connection terminal and a battery door, while an electronic component incorporated in the troubled-ear ear cell is a rear microphone.

3. The hearing aid of claim 1 or 2, wherein a time delay parameter in the digital amplifier is designed to adjust a directional performance in the hearing aid.
